(19) United States
(12) Patent Application Publication
(10) Pub. No.: US 2008/0112648 A1
(43) Pub. Date: May 15, 2008

(54) Image processor and image processing method

(76) Inventor: Toshinobu Hatano, Kyoto (JP)

Correspondence Address: MCDERMOTT WILL & EMERY LLP, 600 13TH STREET, NW, WASHINGTON, DC, 20005-3096, US

(21) Appl. No.: 11/979,671

(22) Filed: Nov. 7, 2007

(30) Foreign Application Priority Data
Nov. 9, 2006 (JP) 2006-303739

(51) Int. Cl. G06K 9/32

(52) U.S. Cl. 382/298

(57) ABSTRACT

An information processor for resizing at least a part of an image includes a split section for splitting the image into a plurality of split images in a specific direction; a resize section for resizing at least one of the plurality of split images at an arbitrary ratio in the specific direction; and an image combining section for again combining the plurality of split images containing the resized split image to generate a composite image.

### BACKGROUND

This invention relates to an image processor and an image processing method for resizing at least a part of an image.

In recent years, a digital camera requiring neither a film nor developing has shown activity. Also in mobile telephones, those installing a digital camera become dominant. Improvement and widespread use of the technology in speeding up and higher image quality of the digital camera are remarkable.

On the other hand, to take a photograph of a person, the photographed person has a wish of being “photographed more beautifully” as the essential demand of the human being.

At present, to perform retouch processing of a person image with a digital camera, after a person is photographed, the image data provided by photographing the person is once input to a PC. It is a common practice to correct the whole balance or an image of any desired part by putting photo retouch software to full use. Performing uniform resize processing in the horizontal direction and the vertical direction with the camera main body is realized. (Refer to JP-A-11-88906)

FIG. 11 is a block diagram to show a digital camera in a related art. With the digital camera, the image data of a subject input with an image pickup unit 501 is stored in memory 531 in an image processor 503. A data extraction section 532 extracts data of a specific portion used for color adjustment from the image data and creates a histogram. A table creation section 533 creates a color conversion table for converting the image data into a proper tint based on the histogram. An image format conversion section 534 converts the image data stored in the memory 531 into the image format of a general photo size based on the data in the color conversion table and retains the image in a record unit 504 and also displays the image on a screen of an output unit 505.

The user visually observes the image displayed on the screen of the output unit 505 and operates an input unit 502 to adjust the RGB color balance for correcting the tint to a more natural or favorite tint.

Thus, the image processor 503 installed in the digital camera converts the image data by paying attention to the tint to obtain a more beautiful image. That is, the tint of the image before retention processing is adjusted, whereby image processing can be performed easily and a high-quality image can be provided.

However, the image processor 503 adjusts the tint, but faithfully processes the original image about the style of the person. To perform retouch processing, use of a high-performance PC and software is a prerequisite and to use them, a technique is required and time and labor are taken.

### SUMMARY

It is an object of the invention to provide an image processor and an image processing method capable of easily deforming a subject on an image by resizing at least a part of the image.

According to the invention, there is provided an image processor for resizing at least a part of an image, the image processor including a split section for splitting an image into a plurality of split images in a specific direction; a resize section for resizing at least one of the plurality of split images at an arbitrary ratio in the specific direction; and an image combining section for again combining the plurality of split images containing the resized split image to generate a composite image. Thus, such image resize processing of changing the style of a person can be performed easily.

In the image processor, the resize section resizes the plurality of split images at the same ratio in the direction orthogonal to the specific direction. Accordingly, resize processing to provide any desired image can be performed easily.

The image processor further includes a setting section for setting a split position of an image and a display processing section for performing processing so as to display a line indicating the split position on a monitor with the line superposed on the image, and the split section splits the image according to the line indicating the split position. Accordingly, the split region desired by the user can be determined.

The image processor further includes a face detection section for detecting a face of a person in an image; a position estimation section for estimating the position of the face of the person or the position of each part of a body in the image; and a split position determination section for determining a split position of the image in accordance with the estimated position of each part. The split section splits the image in the specific direction based on the determined split position. Accordingly, the split region as containing the specific part is determined automatically and the need for user operation can be eliminated.

In the image processor, each part of the face is at least one of an eye, a nose, and a mouth. Accordingly, resize processing of a face image can be performed easily.

In the image processor, each part of the body is at least one of a neck, a chest neighbor, and a waist. Accordingly, resize processing of an upper-body image and a whole-body image can be performed easily.

The image processor further includes a display processing section for performing processing so as to display a line indicating the split position determined by the split position determination section on a monitor with the line superposed on the image. Accordingly, the automatically determined split region can be checked.

The image processor further includes a setting section for changing the position of the line indicating the split position. Accordingly, the automatically determined split region can be changed and ease of operation of the user can be improved.

The image processor further includes memory for storing data of the image, the plurality of split images, and the composite image, and the image combining section again combines the plurality of split images containing the resized split image on memory space of the memory. Accordingly, a composite image after the resize processing is performed can be easily generated using the memory.

According to the invention, there is provided an image processing method for resizing at least a part of an image, the image processing method including a split step of splitting an image into a plurality of split images in a specific direction; a resize step of resizing at least one of the plurality of split images at an arbitrary ratio in the specific direction; and an image combining step of again combining the plurality of split images containing the resized split image to generate a composite image.

According to the image processor and the image processing method according to the invention, the subject on an image can be easily deformed by resizing at least a part of the image.

### BRIEF DESCRIPTION OF THE DRAWINGS

FIG. 1 is a block diagram to show an image pickup unit according to a first embodiment of the invention;

FIG. 2 is a block diagram to show the internal configuration of a DSP 15;

FIGS. 3A-3C are drawings to show split resize processing;

FIG. 4 is a flowchart to show an image resize processing procedure;

FIG. 5 is a flowchart to show a split resize processing procedure at step S5;

FIG. 6 is a flowchart to show an image resize processing procedure according to a second embodiment of the invention;

FIGS. 7A and 7B are drawings to show an original image and an image after resize processing;

FIGS. 8A and 8B are drawings to show an original image and an image after subjected to resize processing if the eye and neck positions are estimated as specific parts as a result of face detection;

FIGS. 9A and 9B are drawings to show an original image and an image after subjected to resize processing if the neck and waist positions are estimated as specific parts as a result of face detection;

FIG. 10 is a block diagram to show the configuration of a DSP 15 according to another embodiment of the invention; and

FIG. 11 is a block diagram to show a digital camera in a related art.

### DESCRIPTION OF THE PREFERRED EMBODIMENTS

Embodiments of an image processor and an image processing method according to the invention will be discussed with reference to the accompanying drawings. The image processor described below is applied to an image resize processing section installed in an image pickup unit (digital still camera).

### First Embodiment

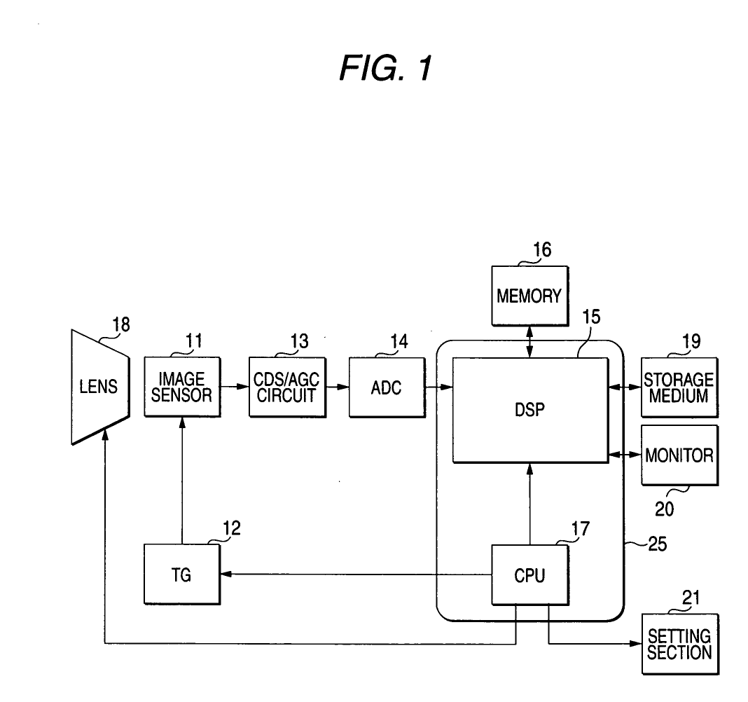

FIG. 1 is a block diagram to show an image pickup unit of a first embodiment of the invention. As shown in FIG. 1, the mage pickup unit of the first embodiment includes a lens 18, an image sensor 11, a timing generator (TG) 12, a CDS/AGC circuit 13, an analog digital converter (ADC) 14, a digital signal processing circuit (DSP) 15, memory 16, a CPU 17, a storage medium 19, a monitor 20, and a setting section 21. The DSP 15 and the CPU 17 make up an image resize processing section 25.

The timing generator 12 generates a drive pulse supplied to the image sensor 11 in accordance with an instruction from the CPU 17. The CDS/AGC circuit 13 removes output noise of the image sensor 11 and controls the gain. Image data and any other data are retained in the memory 16. The ADC 14 converts an analog image signal into digital image data. The CPU 17 executes a control program stored in internal memory, controls the whole image pickup unit, and performs computation processing. The DSP 15 processes the digital image data.

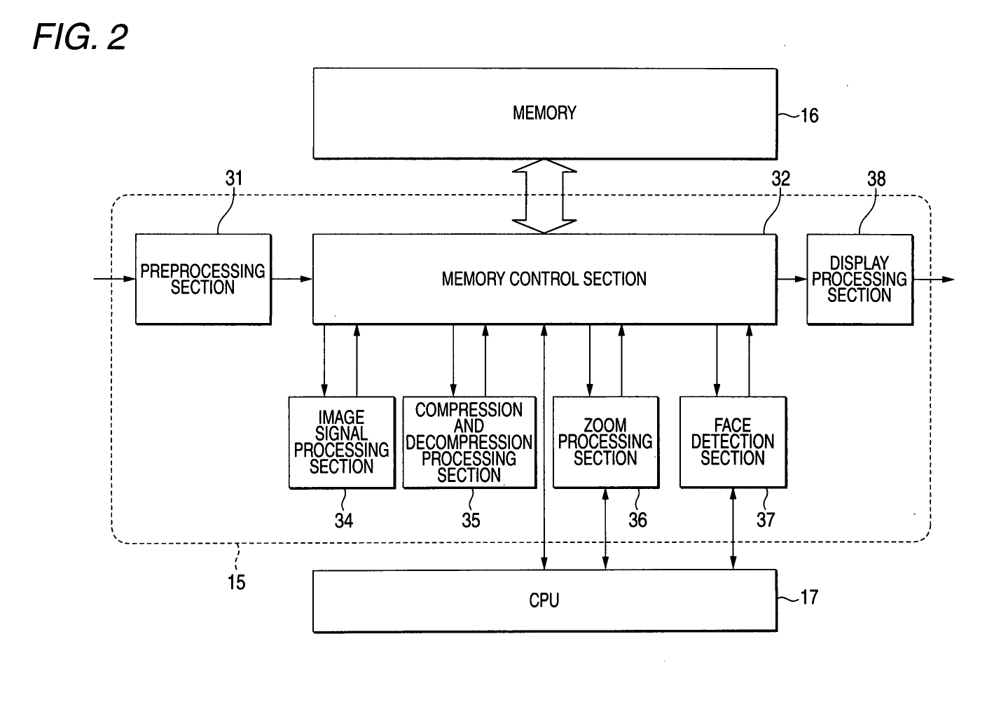

FIG. 2 is a block diagram to show the internal configuration of the DSP 15. The DSP 15 has a preprocessing section 31, a memory control section 32, an image signal processing section 34, a compression and decompression processing section 35, a zoom processing section 36, a face detection section 37, and a display processing section 38.

The preprocessing section 31 makes a black level correction, a gain correction, etc., to the digital image data provided by the ADC 14. The image signal processing section 34 performs luminance signal processing and color signal processing for the digital image data processed by the preprocessing section 31. The compression and decompression processing section 35 compresses image data (luminance signal data and color signal data) and decompresses the compressed image data.

The zoom processing section 36 performs zoom processing as resize processing of the image data. The face detection section 37 detects the face of a person in the image indicated by the image data. The display processing section 38 performs processing for displaying an image on the monitor 20. The memory control section 32 controls data read and write performed between each processing section and the memory 16. The CPU 17 controls the operation of the memory control section 32, the zoom processing section 36, and the face detection section 37. An image resize processing function described later is implemented by the memory control section 32, the memory 16, the zoom processing section 36, the face detection section 37, the display processing section 38, and the CPU 17.

The operation of the image pickup unit of the embodiment is as follows: When image pickup light from a subject is incident on the image sensor 11 through the lens 18, the image pickup light is converted into an electric signal by a photodiode. An analog image signal is output from the image sensor 11 in accordance with a vertical drive signal and a horizontal drive signal synchronized with a drive pulse from the timing generator 12.

1/f noise of the analog image signal output from the image sensor 11 is decreased appropriately by a sample hold circuit (CDS) in the CDS/AGC circuit 13 and then the analog image signal is amplified by automatic gain control (AGC). An output signal from the CDS/AGC circuit 13 is input to the ADC 14, which then converts the signal into digital image data (RGB data).

The digital image data output from the ADC 14 is input to the DSP 15. The DSP 15 performs various types of processing such as luminance signal processing, color separation processing, color matrix processing, resize processing, and data compression processing using the memory 16. The image data subjected to the various types of processing is recorded on the storage medium 19. To reproduce the image data recorded on the storage medium 19, the DSP 15 reads the image data from the storage medium 19, performs decompression processing if the image data is compressed, and performs resize processing in agreement with the display size of the monitor 20 and then outputs the image data to the monitor 20.

The resize processing of the image data will be discussed in detail. When the digital image data is input to the DSP 15, it undergoes black level adjustment and gain adjustment in the preprocessing section 31 and then is written into the memory 16 by the memory control section 32. The image signal processing section 34 reads the image data written into the memory 16, performs luminance signal processing and color signal processing, and converts the image data into luminance data and color difference data (or RGB data). The luminance data and the color difference data (or RGB data) are written into the memory 16 by the memory control section 32.

The image data to be subjected to resize processing is the luminance data and the color difference data (or RGB data). The zoom processing section 36 performs resize processing for the image data read from the memory 16 in the horizontal direction and the vertical direction. Then, the image data subjected to the resize processing is written into the memory 16 by the memory control section 32.

The image data is subjected to the resize processing over the full screen in the horizontal direction and the vertical direction in the zoom processing section 36 so that the image data is output to the display processing section 38 in the size appropriate for the operator to check the image. The resize processing for the display processing (here, referred to as display resize processing) is different processing from split resize processing (described later) performed in the embodiment.

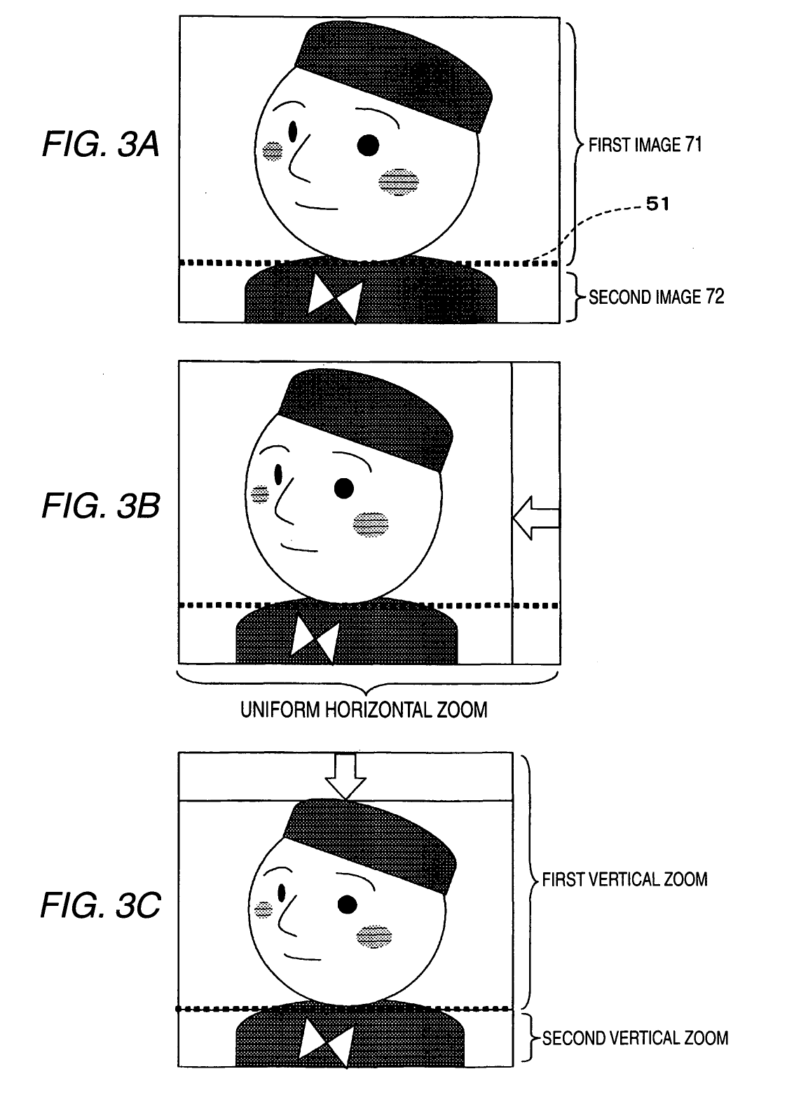

FIGS. 3A and 3B are drawings to show split resize processing. It shows a face image of a human being. FIG. 3A shows an original image. FIG. 3B shows an image provided by performing zoom processing uniform in the horizontal direction (reduction processing) for the image in FIG. 3A. FIG. 3C shows an image provided by performing zoom processing non-uniform in the vertical direction (reduction processing) for the image in FIG. 3B. The zoom processing contains not only the reduction processing, but also the enlargement processing.

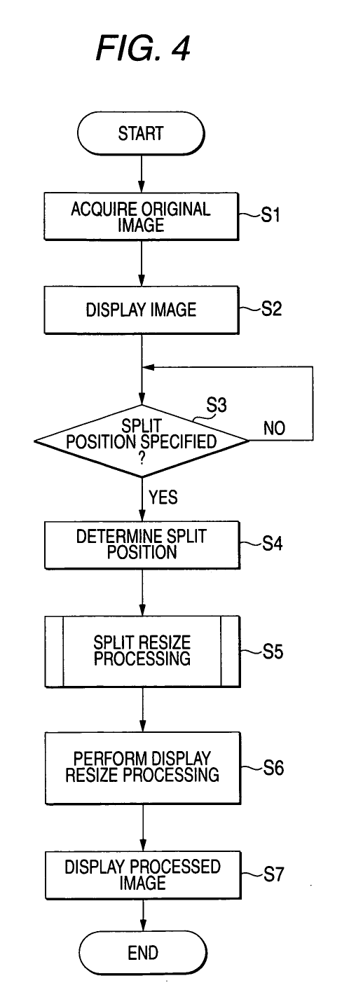

FIG. 4 is a flowchart to show an image resize processing procedure in the first embodiment of the invention. A program for performing the image resize processing is stored in internal memory of the CPU 17 and is executed by the CPU 17. The CPU 17 reads original image data stored in the memory 16 by the memory control section 32 (step S1) and outputs the image data to the display processing section 38. After the image data is processed in the display processing section 38, an image displayed on the monitor 20 (step S2).

The CPU 17 waits for the operator to specify a split position for the image displayed on the monitor 20 through the setting section 21 (step S3). The operator can change the split position by operating any of up, down, left, and right arrow keys (not shown) provided on the setting section 21. Further, to confirm the split position, the operator presses an OK key (not shown) provided on the setting section 21.

When the split position is specified, the CPU 17 determines (computes) the split position corresponding to the specified split position (step S4). At step S4, a line indicating the split position (split line) is superposed on the image on the display by the display processing section 38. In FIG. 3A, a dashed line indicating the split position is displayed in the horizontal direction. In this case, the original image is split into a first image 71 and a second image 72.

The zoom processing section 36 performs split resize processing for the image for which the split position is specified (step S5). As the split resize processing is performed, the final image after the resize processing in FIG. 3C is generated from the image in FIG. 3A through the image in FIG. 3B. The split resize processing is described later in detail.

The zoom processing section 36 performs display resize processing for the image after the split resize processing (FIG. 3C) (step S6). The CPU 17 uses the memory control section 32 and the display processing section 38 to display an image based on the image data resulting from performing the display resize processing on the monitor 20 (step S7). The image data after subjected to the resize processing is retained on the storage medium 19. After this, the image resize processing is terminated.

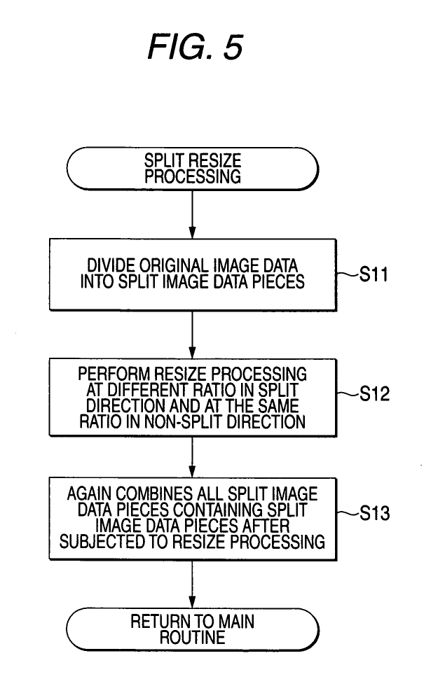

FIG. 5 is a flowchart to show the split resize processing procedure at step S5. The zoom processing section 36 divides the image data into a plurality of split image data pieces in accordance with the split position determined at step S4 (step S11). The CPU 17 manages the memory addresses of the split image data pieces. The zoom processing section 36 performs resize processing at a different ratio in the split direction (in FIGS. 3A-3C, the vertical direction) and at the same ratio in the non-split direction (in FIGS. 3A-3C, the horizontal direction) for each of the split image data pieces (step S12).

Known calculation methods of interpolation, averaging, simple enlargement and reduction, etc., are used for the resize processing. Particularly, in the calculation method using interpolation capable of performing resize processing of high image quality, “bicubic,” “bilinear,” “nearest neighbor,” etc., is adopted and the calculation methods are not limited in the embodiment.

After performing the resize processing, the CPU 17 again combines all split image data pieces containing the split image data pieces after subjected to the resize processing to generate one image data (composite image data) (step S13).

As described above, according to the image pickup unit of the first embodiment, the original image is split in a specific direction and the split image is resized at any desired ratio in the specific direction and then the split image data pieces can be again combined. Thus, the subject on the image can be deformed easily. Consequently, a person image (face image) can be provided along desires such as “being slim,” “becoming beautiful,” “bright eyes,” and “like a small face” of the essential demands of the human being (particularly woman).

### Second Embodiment

In the first embodiment, the operator specifies the split position while seeing the image displayed on the monitor, but the split position is automatically determined in a second embodiment of the invention. The configuration of an image pickup unit of the second embodiment is similar to that of the first embodiment and therefore will not be discussed again. However, image resize processing of the second embodiment differs from the image resize processing of the first embodiment.

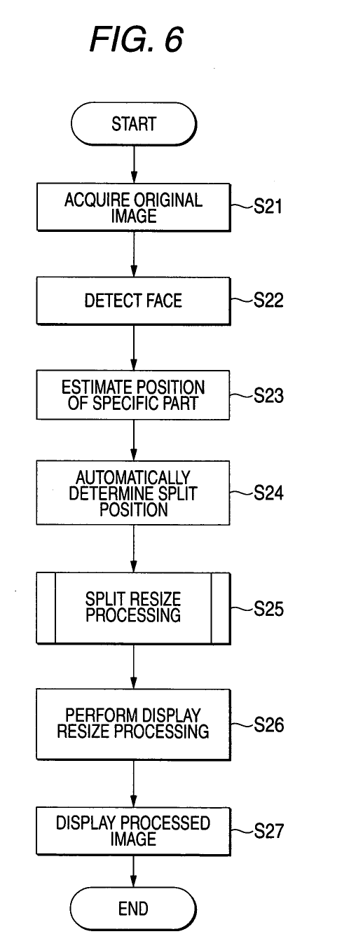

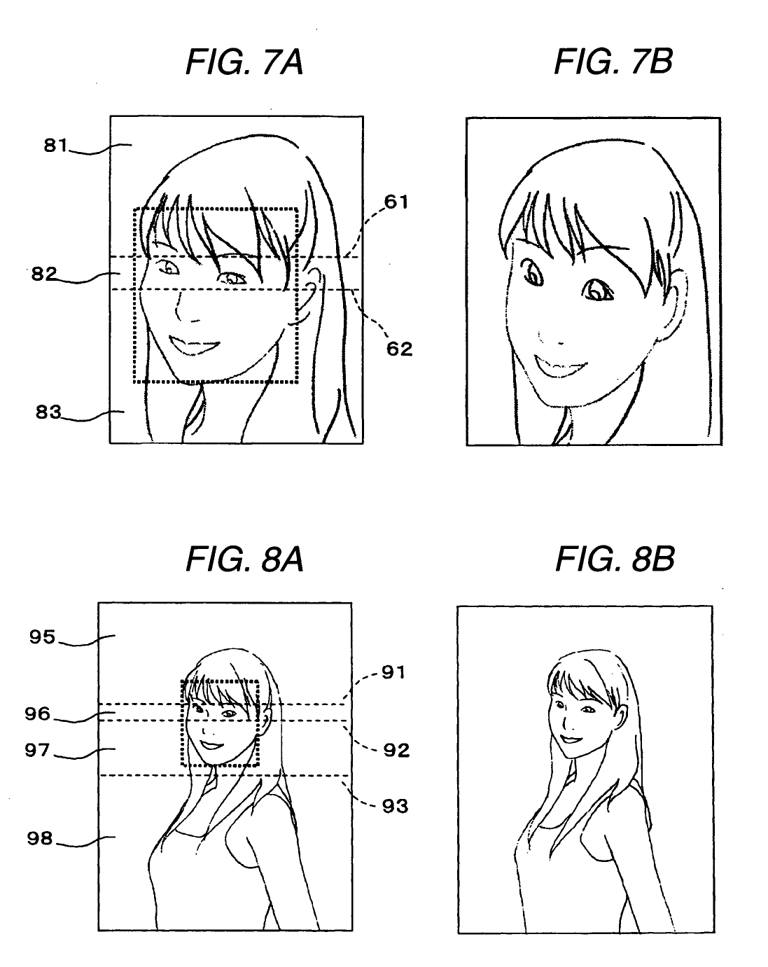

FIG. 6 is a flowchart to show an image resize processing procedure in a second embodiment of the invention. A program for performing the image resize processing is stored in internal memory of a CPU 17 and is executed by the CPU 17. FIGS. 7A and 7B are drawings to show an original image and an image after resize processing. FIG. 7A shows an original image and FIG. 7B shows an image after resize processing (split resize processing and display resize processing).

The CPU 17 reads original image data stored in memory 16 by a memory control section 32 and sends the image data to a face detection section 37 (step S21). In the example shown in FIGS. 7A and 7B, the face image data of a person (woman) shown in FIG. 7A is read. The face detection section 37 detects the face of the person in the image indicated by the image data (step S22). In the face detection processing, the face detection section 37 acquires information the center position and the size of the face. Various face detection methods are proposed and the face detection method is not limited. For example, “Gerber wavelet conversion+graph matching,” “proper face method,” “local feature analysis method,” “kernel determination analysis method,” etc., can be used. The face detection processing may be performed for an image subjected to resize processing equal in horizontal and vertical directions (display resize processing) in place of the original image.

The CPU 17 estimates the position of a specific part in the person image based on the acquired face center position and size information (step S23) and automatically determines (computes) the split position on the image based on the estimated position of the specific part (step S24). In the embodiment, as the specific part, the eye neighbor (eyes) is estimated from the demand of “bright eyes.” As the specific part in a face, an eye, a nose, a mouth, an ear, etc., can be named. In FIG. 7A, the automatically determined split positions are represented by dashed lines 61 and 62 in the horizontal direction passing through the top and bottom of the eye neighbor for the face image on the screen. In this case, the number of splits N is a value 3 and the original image is split into three split images (strip images) made up of a first image 81, a second image 82, and a third image 83.

The CPU 17 performs split resize processing by a zoom processing section 36 for the original image whose split positions are indicated as in the first embodiment (step S25). In the embodiment, the first image 81 and the third image 83 are subjected to the resize processing in the vertical direction (split direction) at the same ratio (equal magnification processing) and the second image 82 is subjected to the resize processing at a larger ratio than that for the first image 81, the third image 83 (enlargement processing). The first image 81, the second image 82, and the third image 83 are subjected to equal magnification processing in the horizontal direction (non-split direction). The method of the resize processing is similar to that of the first embodiment.

The CPU 17 performs display resize processing by the zoom processing section 36 for the image after subjected to the split resize processing (step S26). Further, the CPU 17 uses the memory control section 32 and the display processing section 38 to display an image subjected to the display resize processing on the monitor 20 (step S27). The image data after subjected to the resize processing is retained on a storage medium 19. After this, the processing is terminated.

Thus, according to the image resize processor of the second embodiment, the image resize processing can be executed as automatic processing without the need for the operator to perform input setting. Accordingly, user operation can be remarkably simplified.

The invention is not limited to the specific embodiments described above. For example, the CPU may estimate (compute) a chest neighbor position, a waist position, etc., in accordance with the standard proportion of a human body from the split position on the original image corresponding to any desired part inside the face of a person (for example, eye) and the face size and may determine a plurality of split positions for the original image. Then, the CPU may perform zoom processing at a different ratio in the vertical direction (split direction) and at the same ratio in the horizontal direction (non-split direction) for each of the strip image data pieces provided by splitting the original image and may combine the strip image data pieces on memory space after the resize processing to generate one image (composite image).

Specifically, in the second embodiment (see FIGS. 7A and 7B), the eye neighbor (eye) is estimated as the specific part based on the face image information, but if the person image is an upper body, further a neck and a chest neighbor may be estimated as specific parts based on the face image information. FIGS. 8A and 8B is a drawing to show an original image and an image after subjected to resize processing if the eye and neck positions are estimated as specific parts as a result of face detection. FIG. 8A shows the original image and FIG. 8B shows an image after resize processing (split resize processing and display resize processing). In this case, as the specific part, the neck position is estimated in accordance with the standard proportion of a human body based on the face size and the eye and mouth positions obtained as a result of face detection.

In FIG. 8A, the dynamically determined split positions with the eye neighbor and the neck as the specific parts are displayed on a screen as they are superposed on the original image with dashed lines 91, 92, and 93 in the horizontal direction. In this case, the number of splits N is a value 4 and the original image is split into four split images (strip images) made up of a first image 95, a second image 96, a third image 97, and a fourth image 98. The first image 95 and the third image 97 are subjected to the resize processing in the vertical direction (split direction) at the same ratio (equal magnification processing) and the second image 96 is subjected to the resize processing at a larger ratio than that for the first image, the third image (enlargement processing) and the fourth image 98 is subjected to the resize processing at a smaller ratio than that for the first image, the third image (reduction processing). The first image 95, the second image 96, the third image 97, and the fourth image 98 are subjected to reduction processing at the same magnification ratio in the horizontal direction (non-split direction). The resize processing is similar to that of the first embodiment and therefore will not be discussed again.

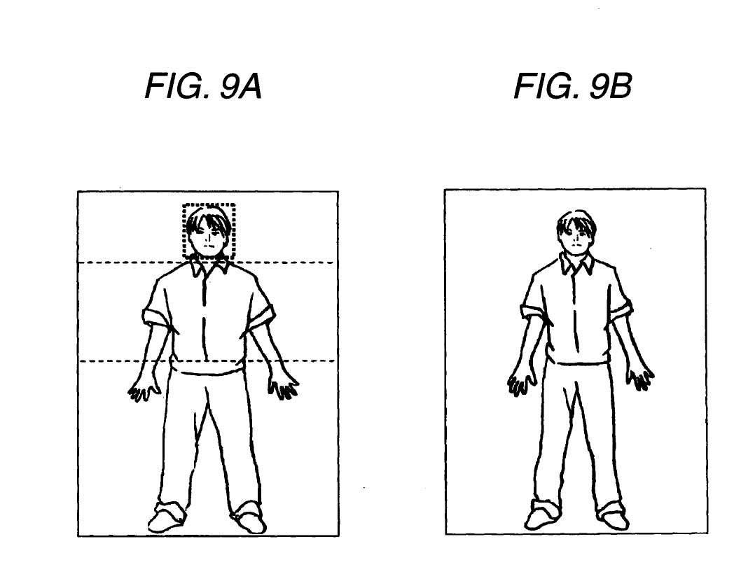

FIGS. 9A and 9B is a drawing to show an original image and an image after subjected to resize processing if the neck and waist positions are estimated as specific parts as a result of face detection. In FIG. 9A, the neck and waist positions are estimated from the detected face position and size and the split positions are determined based on the neck and waist positions. In this case, the number of splits is a value 3 and resize processing is performed in a similar manner.

In the second embodiment, the position of any desired part of a face is assumed from the face center position and size information, but a specific part of a person may be estimated by adding up and down and side-to-side inclination information of a face and rotation information relative to the reference axis. Accordingly, the estimation accuracy of a specific part can be enhanced and further the intended split position can be made precise.

In the embodiment described above, to use face detection processing, automatically the resize processing is started. However, depending on the detection result, a plurality of split positions may be displayed as split lines on a screen by the display processing section as they are superposed and after the operator checks, the resize processing may be performed. That is, the operator may be enabled to change the line indicating the split position through the setting section 21 for the lines indicating the automatically determined split positions displayed as superposed on the original image on the screen of the monitor 20; convenience of operation can be improved. This processing is useful when the resize processing in FIGS. 7A, 7B, 8A, 8B, 9A and 9B is performed.

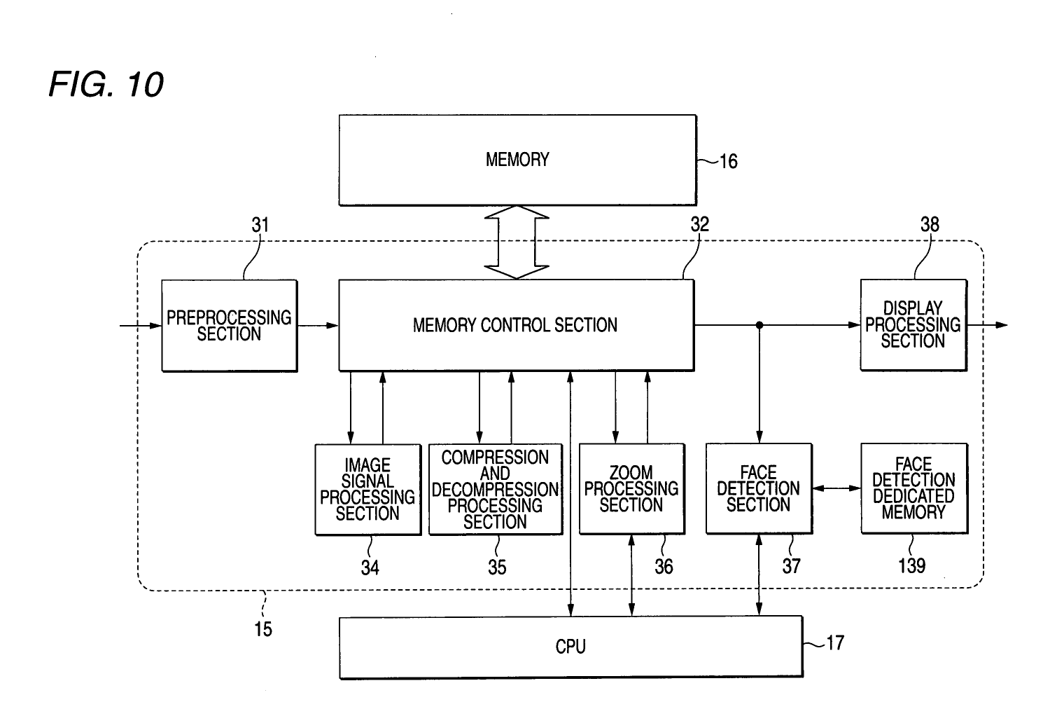

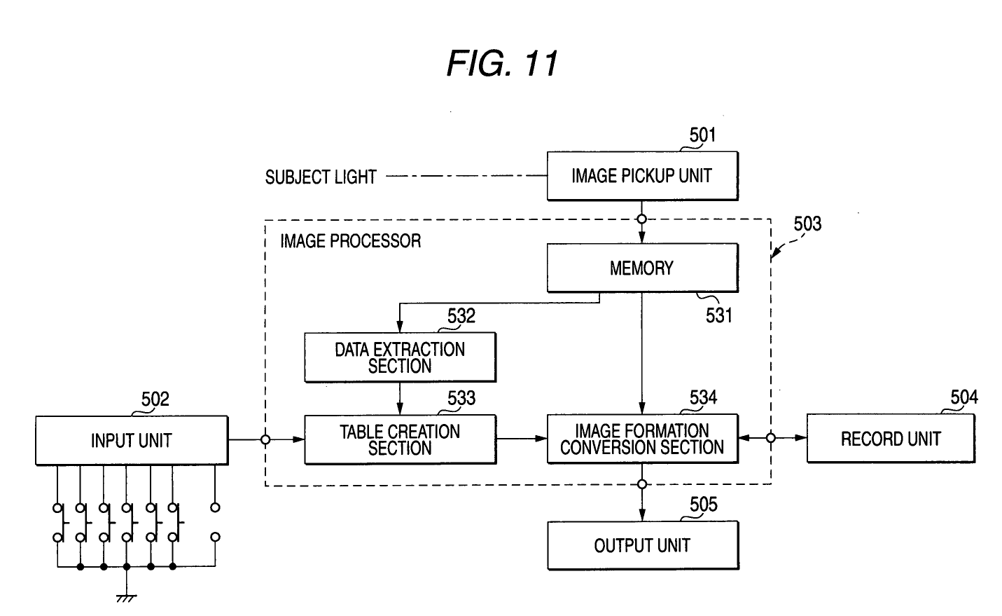

In the first embodiment, the image data is read from the memory 16 by the memory control section 32 and is transferred to the face detection section 37, which then detects face information. However, to decrease the data traffic of the memory control section 32, face detection dedicated memory may be provided. FIG. 10 is a block diagram to show the configuration of a DSP 15 in another embodiment of the invention. Components identical with those of the first embodiment are denoted by the same reference numerals in FIG. 10 and will not be discussed again. A face detection section 37 is provided with face detection dedicated memory 139. Input data to a display processing section 38 is read into the face detection dedicated memory 139 and is used for face detection processing of the face detection section 37. Therefore, the data traffic of the memory control section 32 can be decreased remarkably.

In the embodiments described above, the case where an image is split in the vertical direction is shown, but an image may be split in the horizontal direction and the invention can be applied in a similar manner.

The image processor according to the invention can easily deform a subject on an image and is useful as an image processor for resizing at least a part of the image or the like.

What is claimed is:

1. An image processor for resizing at least a part of an image, the image processor comprising:
a split section that splits the image into a plurality of split images in a specific direction;
a resize section that resizes at least one of the plurality of split images at an arbitrary ratio in the specific direction; and
an image combining section that combines the plurality of split images containing the resized split image to generate a composite image.

2. The image processor according to claim 1, wherein the resize section resizes the plurality of split images at the same ratio in a direction orthogonal to the specific direction.

3. The image processor according to claim 1 further comprising:
a setting section that sets a split position of the image; and
a display processing section that performs processing so as to display a line indicating the split position on a monitor with the line superposed on the image,
wherein the split section splits the image according to the line indicating the split position.

4. The image processor according to claim 1 further comprising:
a face detection section that detects a face of a person in the image;
a position estimation section that estimates the position of the face of the person or the position of each part of a body in the image; and
a split position determination section that determines a split position of the image in accordance with the estimated position of the face or each part,
wherein the split section splits the image in the specific direction based on the determined split position.

5. The image processor according to claim 4, wherein each part of the face includes at least one of an eye, a nose, and a mouth.

6. The image processor according to claim 4, wherein each part of the body includes at least one of a neck, a chest neighbor, and a waist.

7. The image processor according to claim 4 further comprising a display processing section that performs processing so as to display a line indicating the split position determined by the split position determination section on a monitor with the line superposed on the image.

8. The image processor according to claim 7 further comprising a setting section that changes the position of the line indicating the split position.

9. The image processor according to claim 1 further comprising a memory for storing data of the image, the plurality of split images, and the composite image,
wherein the image combining section combines the plurality of split images containing the resized split image on memory space of the memory.

10. An image processing method of resizing at least a part of an image, the method comprising:
splitting the image into a plurality of split images in a specific direction;
resizing at least one of the plurality of split images at an arbitrary ratio in the specific direction; and
combining the plurality of split images containing the resized split image to generate a composite image.
